(19) United States
(12) Patent Application Publication
(10) Pub. No.: US 2024/0385861 A1
(43) Pub. Date: Nov. 21, 2024

(54) EMULATED DEVICE MANAGEMENT SYSTEM

(71) Applicant: Dell Products L.P., Round Rock, TX (US)

(72) Inventor: Boris Glimcher, Brooklyn, NY (US)

(21) Appl. No.: 18/319,666

(22) Filed: May 18, 2023

(51) Int. Cl. G06F 9/455; G06F 13/10

(52) U.S. Cl. CPC G06F 9/455; G06F 13/102

(57) ABSTRACT

An emulated device management system includes a chassis housing a device emulation subsystem coupled to an operating system via operating system physical connection(s) and to a management system via management system physical connection(s). The device emulation subsystem emulates a physical device to provide an emulated device that is presented to the operating system as a local device connected to the operating system physical connection(s), and presented to the management system as a local device connected to the management system physical connection(s). When the device emulation subsystem receives a management information retrieval request from the management system that is directed to the local device presented to the management system, it retrieves management information for the emulated device and provides the management information to the management system via the management system physical connection(s) such that the management information appears to come from the local device presented to the management system.

### BACKGROUND

The present disclosure relates generally to information handling systems, and more particularly to managing emulated devices provided in information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, sometimes utilize emulated devices in their operation. For example, some server devices include Smart Network Interface Controller (SmartNIC) devices and/or Data Processing Units (DPUs) that are connected via a network to storage devices (e.g., Non-Volatile Memory express (NVMe) over Fabrics (NVMe-oF) storage devices) and that are configured to perform storage device emulation operations (e.g., NVMe emulation) that emulate the network-connected storage devices to present them to a Basic Input/Output System (BIOS) and an operating system in server device as “local” storage devices that are included in the server device and connected to the BIOS and operating system via one or more physical buses or other connections. The emulation of such network-connected storage devices allows the BIOS and operating system of the computing device to utilize those network-connected storage devices while not having to be configured to utilize the network through which they are connected (e.g., some operating systems and/or BIOSs do not support NVMe-oF functionality), but also raise a number of issues.

For example, many server devices are managed using a Baseboard Management Controller (BMC) device such as the integrated DELL® Remote Access Controller (iDRAC) device included in server devices available from DELL® Inc. of Round Rock, Texas, United States. Such BMC devices provide for remote management of the “local” devices included in the server device, but while the emulated storage devices described above are presented as local storage devices to the BIOS and operating system in the server device, conventional storage device emulation systems do not make those emulated storage devices visible to the BMC device. As such, a user of the server device will be able to “see” the emulated storage devices as local storage devices when using the operating system, but will not be able to find those emulated storage devices when accessing the server device via the BMC device. Thus, the conventional management of server devices that utilize emulated storage devices requires multiple management systems, which is undesirable for users that wish to have a single point of management for their server devices and their components.

Accordingly, it would be desirable to provide an emulated device management system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a device emulation engine that is configured to: emulate a physical device to provide an emulated device that is: presented to an operating system as a local device that is connected to the processing system by at least one operating system physical connection; and presented to a management system as a local device that is connected to the processing system by at least one management system physical connection; receive, from the management system via the at least one management system physical connection, a management information retrieval request that is directed to the local device presented to the management system by the emulated device; retrieve, in response to receiving the management information retrieval request, management information for the emulated device; and provide, to the management system via the at least one management system physical connection, the management information such that the management information appears to come from the local device presented to the management system by the emulated device.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system that may include the emulated device management system of the present disclosure.

FIG. 3 is a schematic view illustrating an embodiment of a computing device that may include the emulated device management system of the present disclosure.

FIG. 4 is a schematic view illustrating an embodiment of a device emulation subsystem that may be included in the computing device of FIG. 3 and that may provide the emulated device management system of the present disclosure.

FIG. 5 is a flow chart illustrating an embodiment of a method for managing emulated devices in a computing device.

FIG. 6A is a schematic view illustrating an embodiment of the device emulation subsystem of FIG. 4 operating during the method of FIG. 5.

FIG. 6B is a schematic view illustrating an embodiment of the networked system of FIG. 2 operating during the method of FIG. 5.

FIG. 6C is a schematic view illustrating an embodiment of the computing device of FIG. 3 operating during the method of FIG. 5.

FIG. 7 is a schematic view illustrating an embodiment of the computing device of FIG. 3 operating during the method of FIG. 5.

FIG. 8A is a schematic view illustrating an embodiment of the device emulation subsystem of FIG. 4 operating during the method of FIG. 5.

FIG. 8B is a schematic view illustrating an embodiment of the networked system of FIG. 2 operating during the method of FIG. 5.

FIG. 8C is a schematic view illustrating an embodiment of the networked system of FIG. 2 operating during the method of FIG. 5.

FIG. 8D is a schematic view illustrating an embodiment of the device emulation subsystem of FIG. 4 operating during the method of FIG. 5.

FIG. 9A is a schematic view illustrating an embodiment of the computing device of FIG. 3 operating during the method of FIG. 5.

FIG. 9B is a schematic view illustrating an embodiment of the device emulation subsystem of FIG. 4 operating during the method of FIG. 5.

FIG. 9C is a schematic view illustrating an embodiment of the device emulation subsystem of FIG. 4 operating during the method of FIG. 5.

FIG. 9D is a schematic view illustrating an embodiment of the computing device of FIG. 3 operating during the method of FIG. 5.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

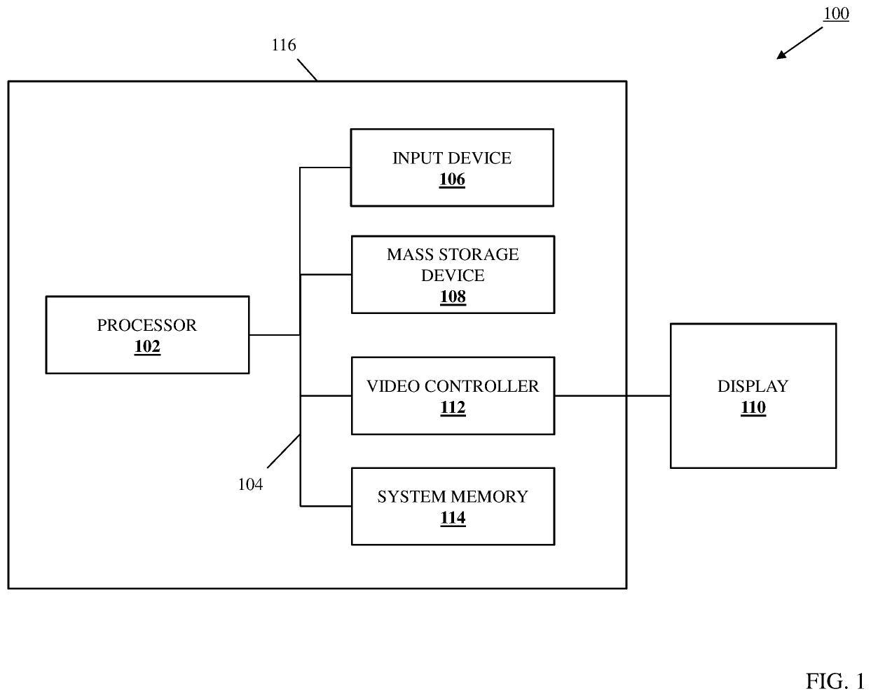

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

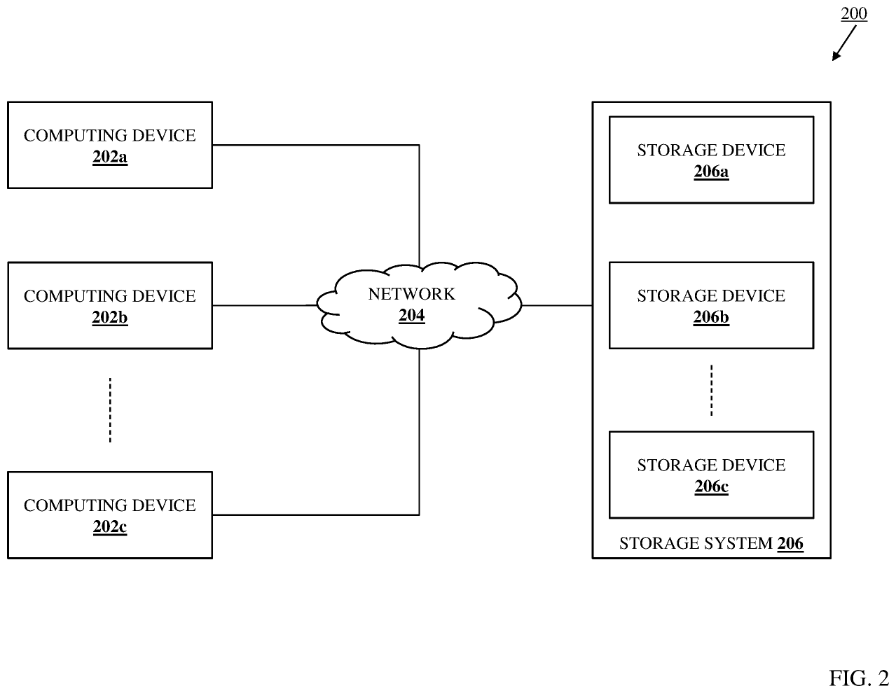

Referring now to FIG. 2, an embodiment of a networked system 200 is illustrated that may include the emulated device management system of the present disclosure. In the illustrated embodiment, the networked system 200 includes a plurality of computing devices 202a, 202b, and up to 202c. In an embodiment, the computing device 202a-202c may be provided by the IHS 100 discussed above with reference to FIG. 1, and/or may include some or all of the components of the IHS 100, and in the specific examples provided below are provided by server devices. However, while illustrated and discussed as being provided by server devices, one of skill in the art in possession of the present disclosure will recognize that computing devices provided in the networked system 200 may include any devices (e.g., desktop computing devices, laptop/notebook computing devices, table computing devices, mobile phones, networking devices (e.g., switch devices), storage systems, etc.) that may be configured to operate similarly as the computing devices 202a-202c discussed below.

In the illustrated embodiment, each of the computing devices 202a-202c are coupled to a network 204 that may be provided by a Local Area Network (LAN), the Internet, combinations thereof, and/or any other networks that would be apparent to one of skill in the art in possession of the present disclosure. Furthermore, the embodiments illustrated and described herein provide a storage system 206 that is coupled to the network 204 and that includes a plurality of storage devices 206a, 206b, and up to 206c. In the specific examples provided below, the storage devices 206a-206c are provided by Non-Volatile Memory express (NVMe) over Fabrics (NVMe-oF) storage devices, but one of skill in the art in possession of the present disclosure will appreciate how other types of storage devices will fall within the scope of the present disclosure as well. Furthermore, while the specific examples provided herein provide for the emulation of network-connected storage devices, one of skill in the art in possession of the present disclosure will appreciate how other types of network-connected devices (and in some cases, other types of local devices) may be emulated (e.g., Graphical Processing Units (GPUs) and/or other computing components that would be apparent to one of skill in the art in possession of the present disclosure) similarly to the network-connected NVMe-OF storage devices described below and managed according to the teachings of the present disclosure while remaining within the scope of the present disclosure. As such, while a specific networked system 200 has been illustrated and described, one of skill in the art in possession of the present disclosure will recognize that networked systems that include the emulated device management system of the present disclosure may include a variety of components and component configurations while remaining within the scope of the present disclosure as well.

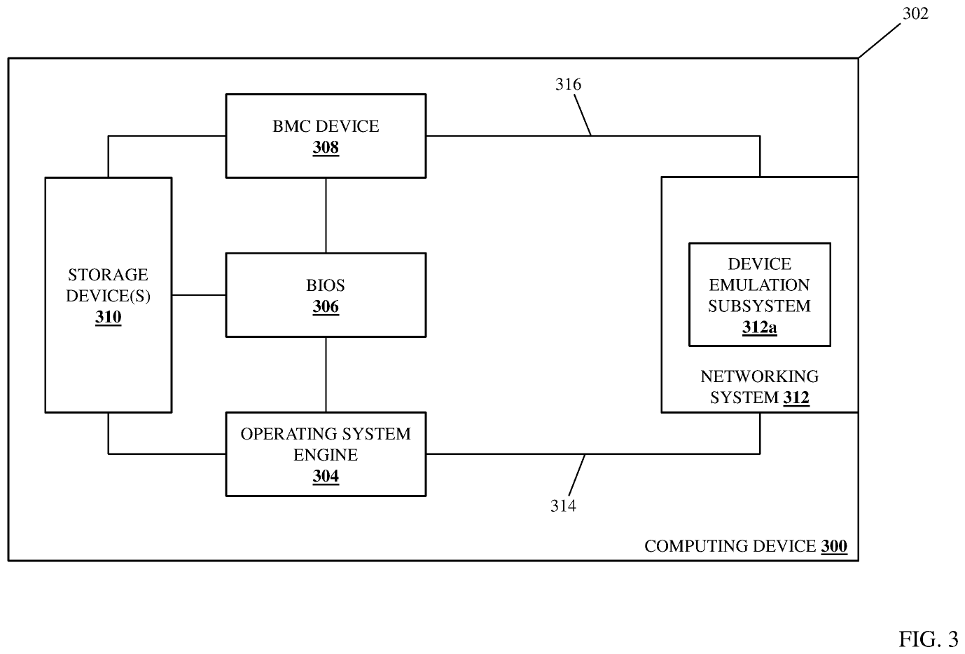

Referring now to FIG. 3, an embodiment of a computing device 300 is illustrated that may provide any or all of the computing devices 202a-202c discussed above with reference to FIG. 2. As such, the computing device 300 may be provided by the IHS 100 discussed above with reference to FIG. 1 and/or may include some or all of the components of the IHS 100, and in specific examples may be provided by a server device. Furthermore, while illustrated and discussed as being provided by a server device, one of skill in the art in possession of the present disclosure will recognize that the functionality of the computing device 300 discussed below may be provided by other devices (e.g., desktop computing devices, laptop/notebook computing devices, table computing devices, mobile phones, networking devices (e.g., switch devices), storage systems, etc.) that are configured to operate similarly as the computing device 300 discussed below.

In the illustrated embodiment, the computing device 300 includes a chassis 302 that houses the components of the computing device 300, only some of which are illustrated and described below. For example, the chassis 302 may house a primary processing system (not illustrated, but which may include the processor 102 discussed above with reference to FIG. 1 such as, for example, a Central Processing Unit (CPU) in a server device) and a primary memory system (not illustrated, but which may include the memory 114 discussed above with reference to FIG. 1 such as for example, Dynamic Random Access Memory (DRAM) devices in a server device) that is coupled to the primary processing system and that includes instructions that, when executed by the primary processing system, cause the primary processing system to provide an operating system engine 304 that is configured to provide an operating system for the computing device 300 and/or otherwise perform the functionality of the operating systems engines and/or computing devices discussed below.

The chassis 302 may house a Basic Input/Output System (BIOS) processing system (not illustrated, but which may include a processor that is similar to the processor 102 discussed above with reference to FIG. 1 and that may be included in BIOS firmware) and a BIOS memory system (not illustrated, but which may include a memory that is similar to the memory 114 discussed above with reference to FIG. 1 and that may be included in BIOS firmware) that is coupled to the BIOS processing system and that includes instructions that, when executed by the BIOS processing system, cause the BIOS processing system to provide an BIOS 306 that is coupled to the operating system engine 304 (e.g., via a coupling between the primary processing system and the BIOS processing system) and that is configured to perform the functionality of the BIOS and/or computing devices discussed below.

As will be appreciated by one of skill in the art in possession of the present disclosure, the BIOS 306 may be configured to perform hardware initialization operations during an initialization/booting process (e.g., a Power-On Self-Test (POST)) for the computing device 300, runtime services for an operating system and applications/programs provided by the computing devices, and/or any other BIOS operations that would be apparent to one of skill in the art in possession of the present disclosure. Furthermore, while described as a BIOS, one of skill in the art in possession of the present disclosure will appreciate how the BIOS 306 may be provided with or replaced by a Unified Extensible Firmware Interface (UEFI) system that is provided according to the UEFI specification and defines the architecture of platform firmware used for initializing/booting the computing device 300, the interface for interaction with the operating system provided by the computing device 300, as well as any other UEFI operations that would be apparent to one of skill in the art in possession of the present disclosure.

The chassis 302 also houses a management system that is, in the illustrated embodiment, is provided by a Baseboard Management Controller (BMC) device 308 that is coupled to the BIOS 306 (e.g., via a coupling between the BMC device 308 and the BIOS processing system). In an embodiment, the BMC device 308 may be provided by the IHS 100 discussed above with reference to FIG. 1 and/or may include some or all of the components of the IHS 100, and in specific examples may be provided by an integrated DELL® Remote Access Controller (iDRAC) device that is available in server devices provided by DELL® Inc. of Round Rock, Texas, United States. As will be appreciated by one of skill in the art in possession of the present disclosure, the iDRAC device (and/or BMC device 308 described herein) may be configured to provide an Out-Of-Band (OOB) management platform for a server device that primarily utilizes compute resources that are separate from those used by that server device, provide an interface (e.g., via a browser or Command Line Interface (CLI)) for managing and monitoring server components, and/or perform other BMC/iDRAC operations that would be apparent to one of skill in the art in possession of the present disclosure.

As illustrated, the chassis 302 may also house one or more storage devices 310 that are coupled to the operating system engine 304 (e.g., via a coupling between that storage device and the primary processing system), the BIOS 306 (e.g., via a coupling between that storage device and the BIOS processing system), and the BMC device 308 via “internal” connections in the chassis 302 (e.g., traces, cabling, etc.) such that those storage device(s) 310 may be considered “local” storage devices for the computing device 300. In the specific examples provided below, the storage device(s) 310 are provided by Non-Volatile Memory express (NVMe) storage devices, but one of skill in the art in possession of the present disclosure will appreciate how other types of storage devices, and/or devices other than storage devices, will fall within the scope of the present disclosure as well.

The chassis 302 may also house a networking system 312 that is coupled to the operating system engine 304 via one or more operating system physical connections 314 (e.g., circuit board traces, cabling, and/or other couplings between the networking system 312 and the primary processing system), that is coupled to the BMC device 308 by one or more management system/BMC device physical connections 316 (e.g., circuit board traces, cabling, etc.), and that may be provided by a Network Interface Controller (NIC) and/or other networking components that would be apparent to one of skill in the art in possession of the present disclosure. In the specific examples provided below, the management system/BMC device physical connections 316 are provided by a Peripheral Component Interconnect express (PCIe) connection and an Inter-Integrated Circuit (I2C) connection, although other management system/BMC device physical connections are envisioned as falling within the scope of the present disclosure as well.

In a specific example, the networking system 312 may be provided by a SmartNIC device (sometimes referred to as a System Control Processor (SCP) device, an Infrastructure Processing Unit (IPU), etc.), which one of skill in the art in possession of the present disclosure will recognize may include a programmable accelerator device that is configured to offload a variety of processing operations from processing systems in the computing device 300 in order to make datacenter networking, security, storage, and/or other computing functionality more efficient and flexible. In the illustrated embodiment, the networking system 312 includes a device emulation subsystem 312a that is described in further detail below and that may be provided by a Data Processing Unit (DPU) that one of skill in the art in possession of the present disclosure will appreciate may include a channel controller provided by a programmable specialized electronic circuit with hardware acceleration for data processing utilized in data-centric computing. However, while described as being provided by a DPU, one of skill in the art in possession of the present disclosure will appreciate how a SmartNIC device may include other SmartNIC processing systems that will fall within the scope of the present disclosure as well.

To provide a specific example, the DPU that provides the device emulation subsystem 312a may include a CPU, a NIC, and one or more programmable data acceleration engines that allow the DPU to include the generality and programmability of CPUs, while being specialized to operate efficiently on networking data packets, storage requests, analytics requests, and/or other data processing requests that would be apparent to one of skill in the art in possession of the present disclosure. Furthermore, while specific examples described above describe a SmartNIC having a DPU that provides the device emulation subsystem 312a of the present disclosure, one of skill in the art in possession of the present disclosure will appreciate that one of the SmartNIC or the DPU discussed above may provide the functionality of the device emulation subsystem 312 described below (e.g., without the need to provide the other) while remaining within the scope of the present disclosure as well. However, while a specific computing device 300 has been illustrated and described, one of skill in the art in possession of the present disclosure will recognize that computing devices (or other devices operating according to the teachings of the present disclosure in a manner similar to that described below for the computing device 300) may include a variety of components and/or component configurations for providing conventional computing device functionality, as well as the emulated device management functionality discussed below, while remaining within the scope of the present disclosure as well.

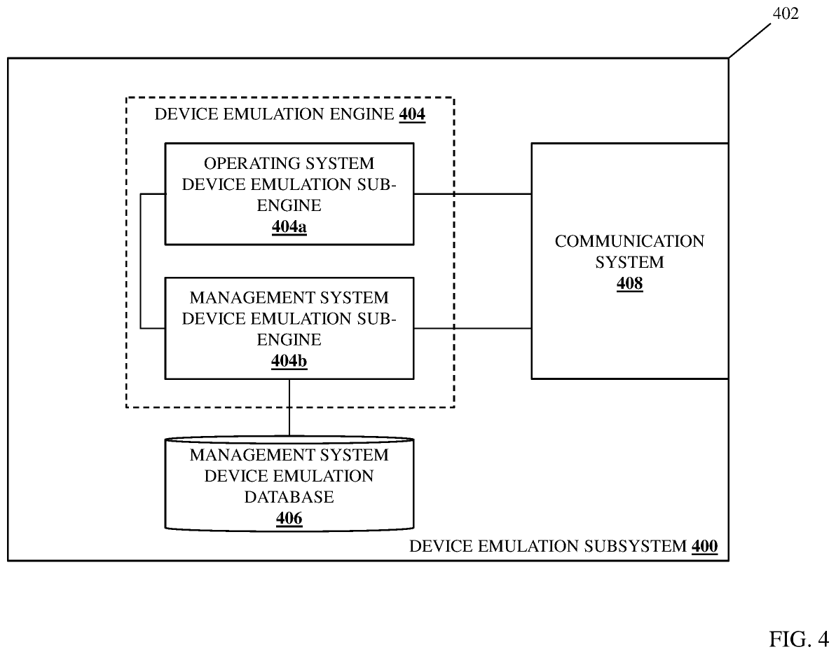

With reference to FIG. 4, an embodiment of a device emulation subsystem 400 is illustrated that may provide the device emulation subsystem 312a discussed above with reference to FIG. 3. As such, in some embodiments the device emulation subsystem 400 may be included in a networking system such as a SmartNIC, and/or may be provided by a DPU, similarly as described above. In the illustrated embodiment, the device emulation subsystem 400 includes a chassis 402 that supports the components of the device emulation subsystem 400, only some of which are illustrated and described below. For example, the chassis 402 may support a device emulation processing system (not illustrated, but which may include a processor that is similar to the processor 102 discussed above with reference to FIG. 1 and that may be provided by a SmartNIC processor, a DPU processor, etc.) and a device emulation memory system (not illustrated, but which may include memory that is similar to the memory 114 discussed above with reference to FIG. 1 and that may be provided by SmartNIC memory, DPU memory, etc.) that is coupled to the device emulation processing system and that includes instructions that, when executed by the device emulation processing system, cause the device emulation processing system to provide a device emulation engine 404 that is configured to perform the functionality of the device emulation engines and/or device emulation subsystems discussed below.

In the specific examples provided below, the chassis 402 supports an operating system device emulation processor (not illustrated, but which may be included in SmartNIC firmware, DPU firmware, etc.) and an operating system device emulation memory (not illustrated, but which may be included in SmartNIC firmware, DPU firmware, etc.) that is coupled to the operating system device emulation processor and that includes instructions that, when executed by the operating system device emulation processor, cause the operating system device emulation processor to provide an operating system device emulation sub-engine 404a that is included in the device emulation engine 404 and that is configured to perform the functionality of the operating system device emulation sub-engines, device emulation engines, and/or device emulation subsystems discussed below.

In the specific examples provided below, the chassis 402 also supports a management system device emulation processor (not illustrated, but which may be included in SmartNIC firmware, DPU firmware, etc.) and a management system device emulation memory (not illustrated, but which may be included in SmartNIC firmware, DPU firmware, etc.) that is coupled to the management system device emulation processor and that includes instructions that, when executed by the management system device emulation processor, cause the management system device emulation processor to provide a management system device emulation sub-engine 404b that is included in the device emulation engine 404 and that is configured to perform the functionality of the management system device emulation sub-engines, device emulation engines, and/or device emulation subsystems discussed below.

As will be appreciated by one of skill in the art in possession of the present disclosure, in some embodiments the operating system device emulation processor and memory described below may be provided in operating system device emulation firmware that is separate from the management system device emulation firmware that includes the management system device emulation processor and memory, and thus the operating system device emulation sub-engine 404a and the management system device emulation sub-engine 404b may be provided by separate firmware devices in the device emulation subsystem 400. However, while a multi-firmware configuration that provides the device emulation engine 404 has been described, other components and/or components configurations for providing the device emulation engine 404 are envisioned as falling within the scope of the present disclosure as well.

In the illustrated embodiment, the chassis 402 may also include a storage device (not illustrated, but which may include a storage device similar to the storage 108 discussed above with reference to FIG. 1) that is coupled to the management system device emulation sub-engine 404b (e.g., via a coupling between the storage device and the management system device emulation processor) and that includes a management system device emulation database 406 that is configured to store any of the information utilized by the management system device emulation sub-engine 404b. The chassis 402 may also include a communication system 408 that is coupled to each of the operating system device emulation sub-engine 404a (e.g., via a coupling between the communication system 408 and the operating system device emulation processor) and the management system device emulation sub-engine 404b (e.g., via a coupling between the communication system 408 and the management system device emulation processor), and that may be provided by a Network Interface Controller (NIC) and/or other communication components that one of skill in the art in possession of the present disclosure would recognize as providing the functionality described below. However, while a specific device emulation subsystem 400 has been illustrated and described, one of skill in the art in possession of the present disclosure will appreciate how the device emulation subsystem of the present disclosure may include a variety of components and/or component configurations while remaining within the scope of the present disclosure as well.

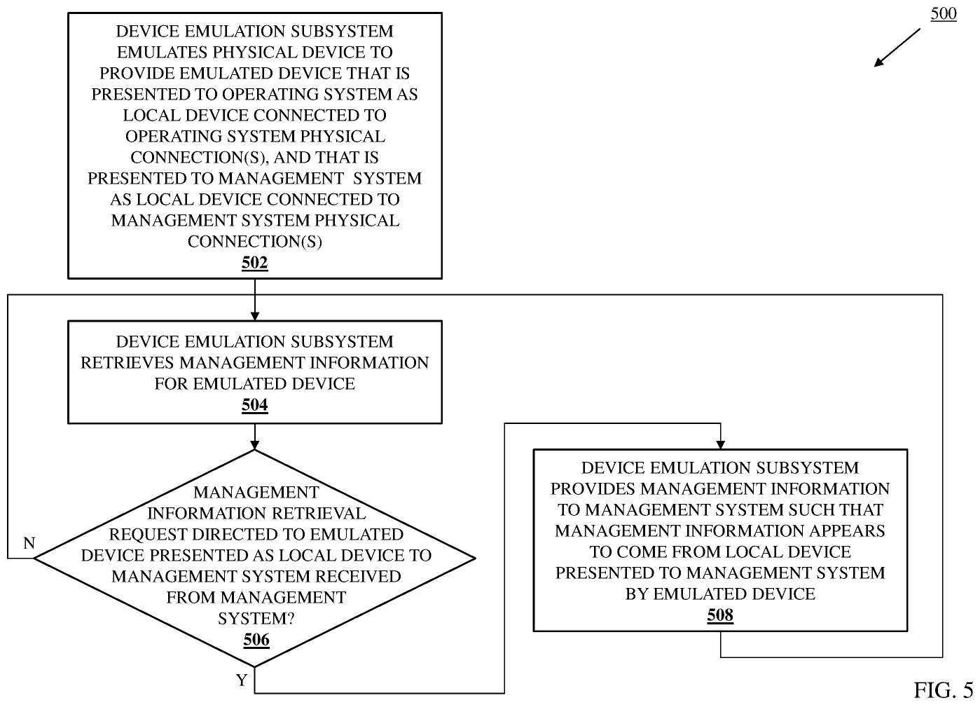

Referring now to FIG. 5, an embodiment of a method 500 for managing emulated devices in a computing device is illustrated. As discussed below, the systems and methods of the present disclosure provide for the emulation of physical devices, which are also being emulated to an operating system in a computing device, to a management system in that computing device as well. For example, the emulated device management system of the present disclosure may include a chassis housing a device emulation subsystem coupled to an operating system via operating system physical connection(s) and to a management system via management system physical connection(s). The device emulation subsystem emulates a physical device to provide an emulated device that is presented to the operating system as a local device connected to the operating system physical connection(s), and presented to the management system as a local device connected to the management system physical connection(s). When the device emulation subsystem receives a management information retrieval request from the management system that is directed to the local device presented to the management system, it retrieves management information for the emulated device and provides the management information to the management system via the management system physical connection(s) such that the management information appears to come from the local device presented to the management system. As such, the same management system in a computing device that is used to manage physical devices in that computing device (i.e., “local” devices) may be used to manage emulated devices utilized by the operating system in that computing device as well.

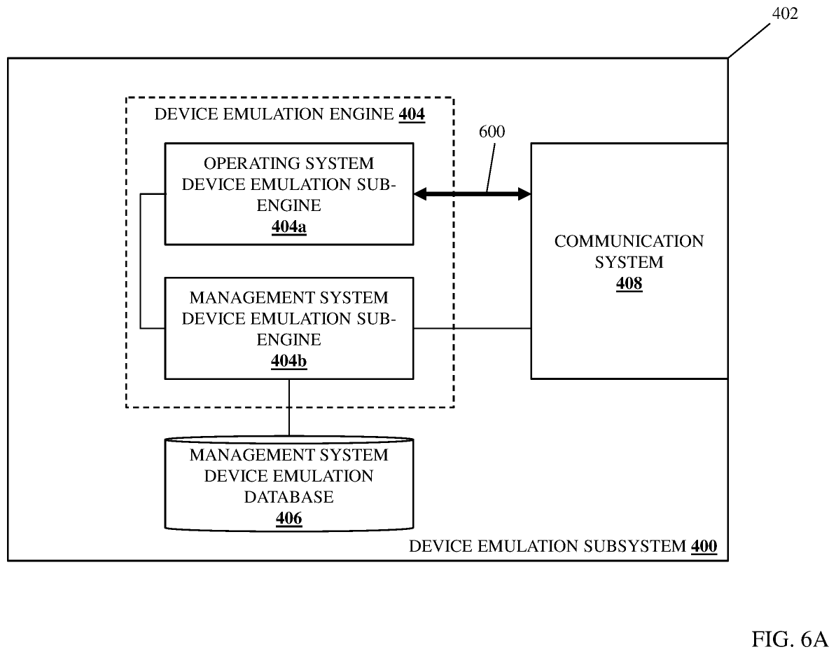

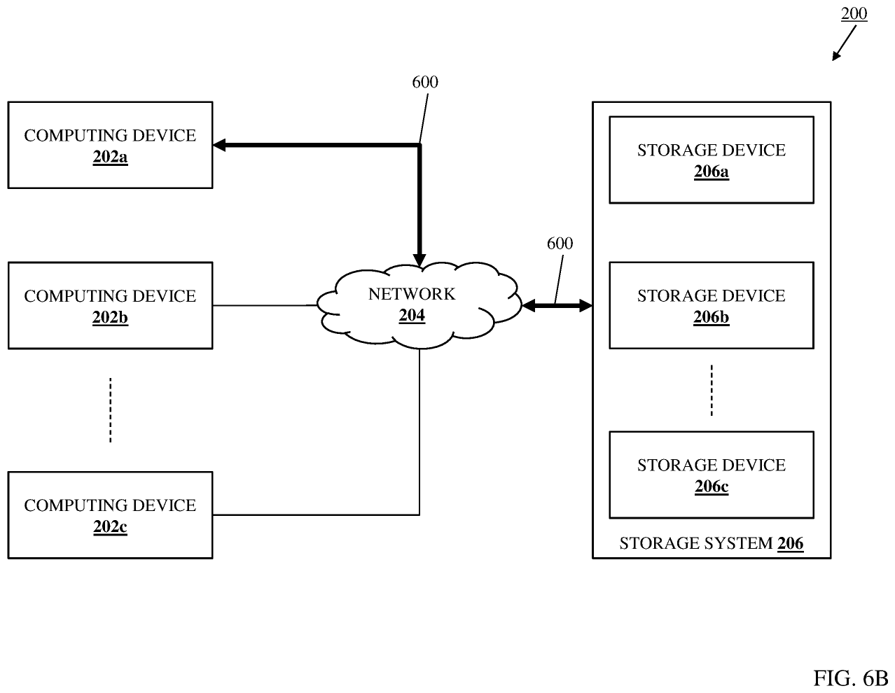

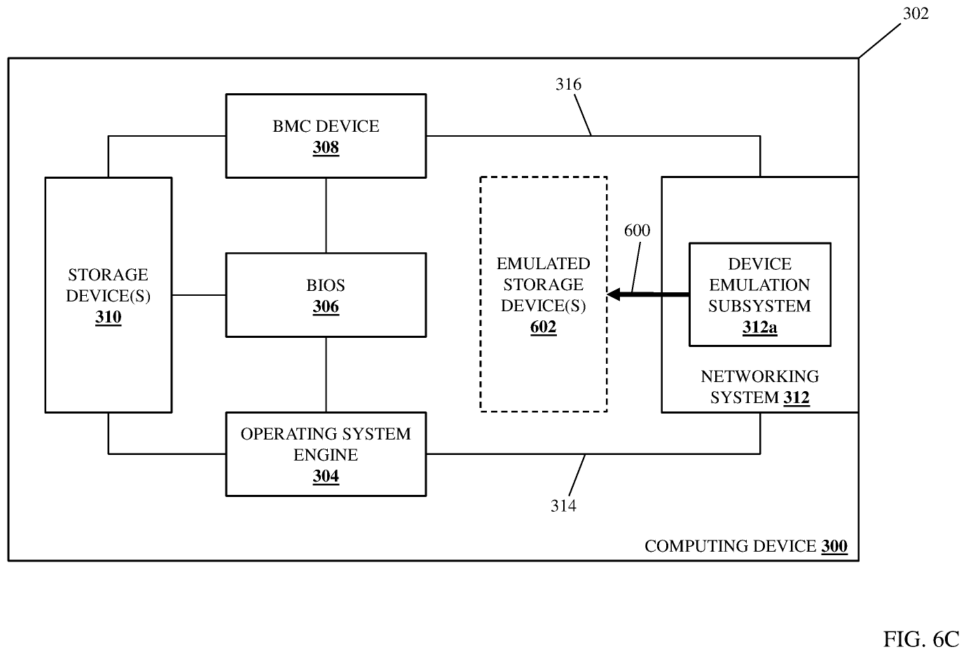

The method 500 begins at block 502 where a device emulation subsystem emulates a physical device to provide an emulated device that is presented to an operating system as a local device that is connected to operating system physical connection(s), and that is presented to a management system as a local device that is connected to management system physical connection(s). With reference to FIGS. 6A, 6B, and 6C, in an embodiment of block 502, the operating system device emulation sub-engine 404a in the device emulation engine 404 of the device emulation subsystem 400 may perform operating system device emulation operations 600 that may include communicating with one or more of the storage devices 206a-206c in the storage system 206 through the network 204 using its communication system 408 and, based at least partly on those communications, emulating those one or more storage devices 206a-206c to provide one or more emulated storage devices 602 in the computing device 300. To provide a specific example, the operating system device emulation operations 600 may include NVMe emulation operations that present one or more NVMe-OF storage devices (e.g., that provide the storage devices 206a-206c included in the storage system 206) as “local” NVMe storage devices to an operating system in the computing device 202a/300.

In a specific example, the operating system device emulation operations 600 performed by the operating system device emulation sub-engine 404a may include presenting the emulated storage device(s) 602 to an operating system provided by the operating system engine 304 in the computing device 300 via the operating system physical connection(s) 314 such that those emulated storage device(s) 602 appear to the operating system as “local” devices that are connected to the operating system physical connection(s) 314. As such, one of skill in the art in possession of the present disclosure will appreciate how the operating system provided by the operating system engine 304 may view the emulated storage device(s) 602 as physical storage devices that are located in the chassis 302 of the computing device 300 and connected to the operating system engine 304 (e.g., connected to the primary processing system that provides the operating system engine 304) via the operating system physical connection(s) 314 (i.e., “local” storage devices).

In addition, as discussed in further detail below and as will be appreciated by one of skill in the art in possession of the present disclosure, the management system device emulation sub-engine 404b may perform management system device emulation operations that include presenting the emulated storage device(s) 602 to the BMC device 308 in the computing device 300 via the management system physical connection(s) 316 such that those emulated storage device(s) 602 appear to the management system as “local” devices that are connected to the management system physical connection(s) 316. In particular, and as discussed in further detail below, the use of the management system physical connection(s) 316 by the BMC device 308 to communicate with the BMC device 308 and “impersonate” the emulated storage device(s) 602 as described below may operate to present the emulated storage device(s) 602 to the BMC device 308 as “local” devices that are connected to the management system physical connection(s) 316. As such, one of skill in the art in possession of the present disclosure will appreciate how the operations of the device emulation subsystem 312a described below may cause the BMC device 308 to view the emulated storage device(s) 602 as physical storage devices that are located in the chassis 302 of the computing device 300 and connected to the BMC device 308 via the management system physical connection(s) 316 (i.e., “local” storage devices).

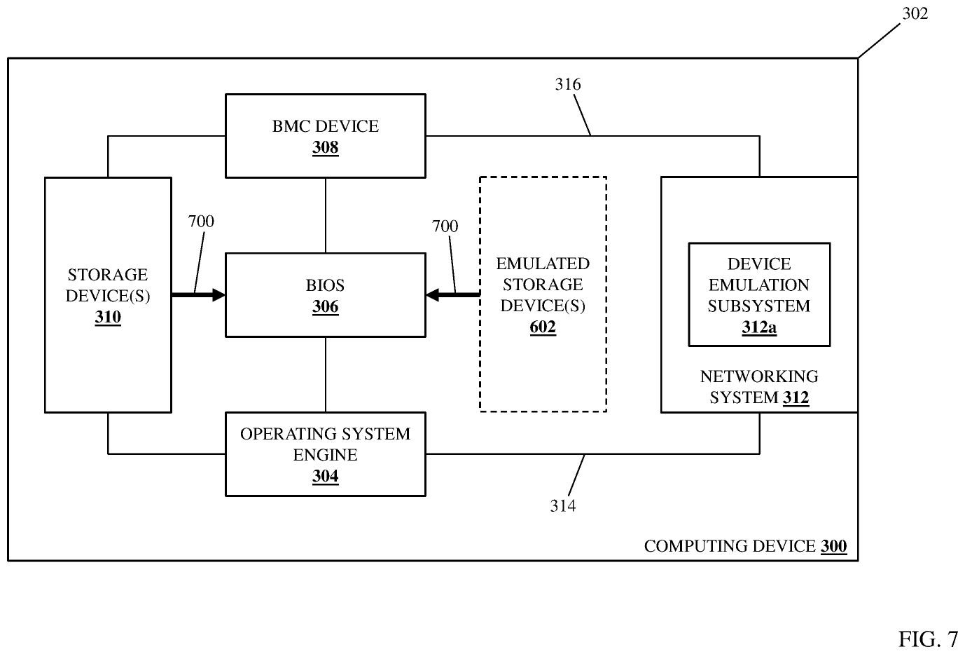

In a specific example of block 502, the operating system device emulation operations 600 performed by the operating system device emulation sub-engine 404a in the device emulation engine 404 of the device emulation subsystem 400 may also include presenting the emulated storage device(s) 602 to the BIOS 306 as “local” storage devices in the computing device 300 in a manner that is similar to that described above for the operating system provided by the operating system engine 304. As such, with reference to FIG. 7 and as part of the initialization/booting of the computing device 300, the BIOS 306 may perform inventory operations 700 that include inventorying the storage device(s) 310 that are local, physical storage devices included in the computing device 300, as well as inventorying the emulated storage device(s) 602 that are being presented to the BIOS 306 as local storage devices included in the computing device 300 (i.e., while the functionality of those emulated storage device(s) 602 is provided by the storage device(s) 206a-206c connected via the network 204).

The method 500 then proceeds to block 504 where the device emulation subsystem retrieves management information for the emulated device. In the embodiments of the present disclosure illustrated and described below, the device emulation engine 404 of the device emulation subsystem 312a/400 may operate to periodically access the storage device(s) 206a-206c that are being used to provide the emulated storage device(s) 602 to retrieve management information for those storage device(s) 206a-206c prior to receiving the management information retrieval requests discussed below in order to, for example, “fetch and cache” that management information so that the management information may be provided to the BMC device 308 relatively quickly when requested. However, as also described below, the management information retrieval operations described as being performed by block 504 and prior to being requested may instead be performed following the receipt of the management information retrieval requests discussed below while remaining within the scope of the present disclosure as well.

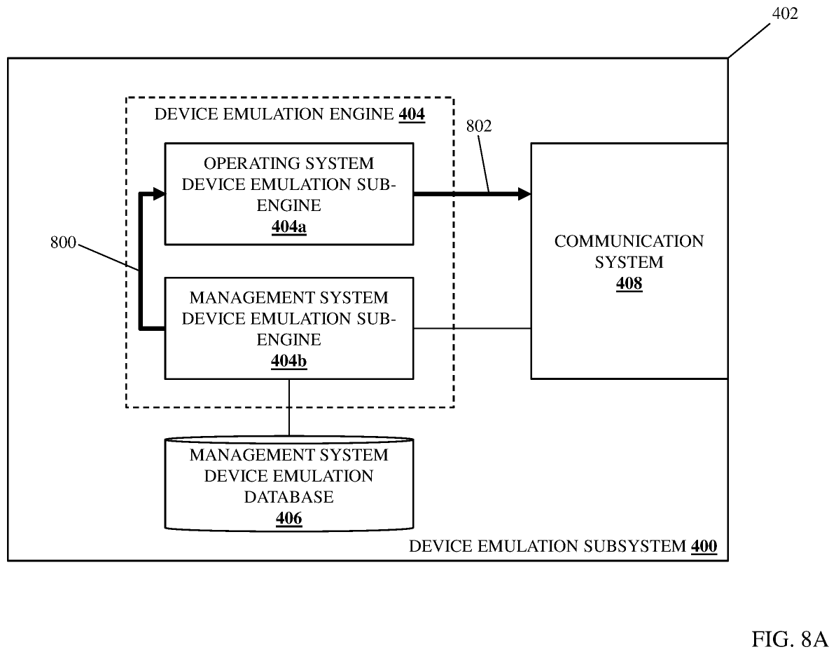

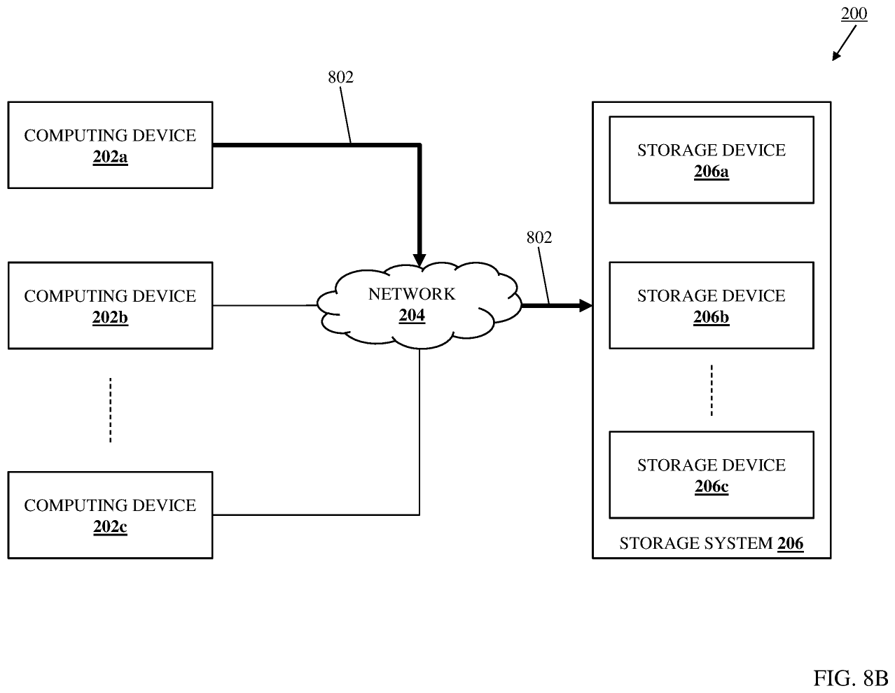

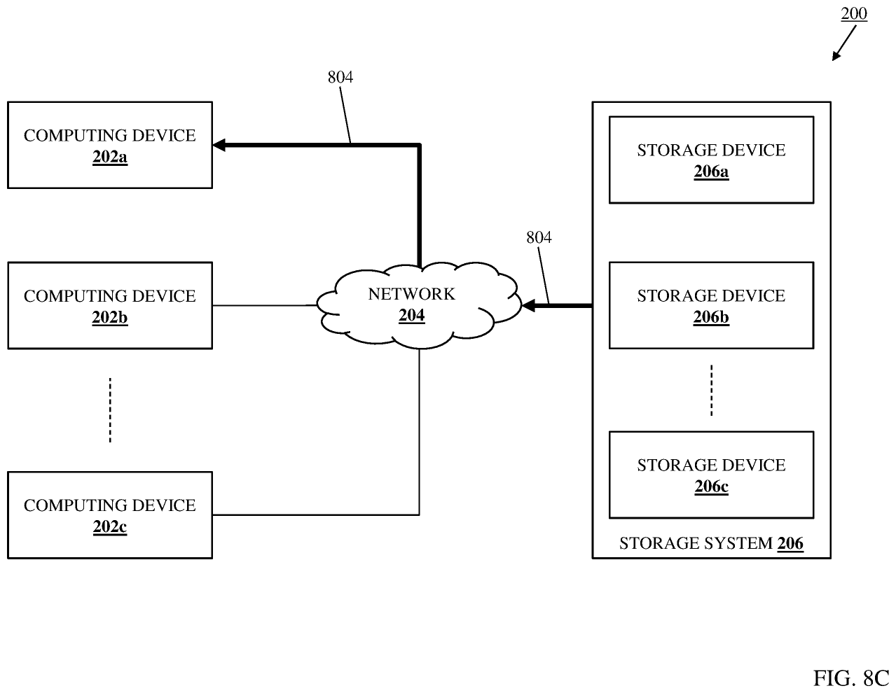

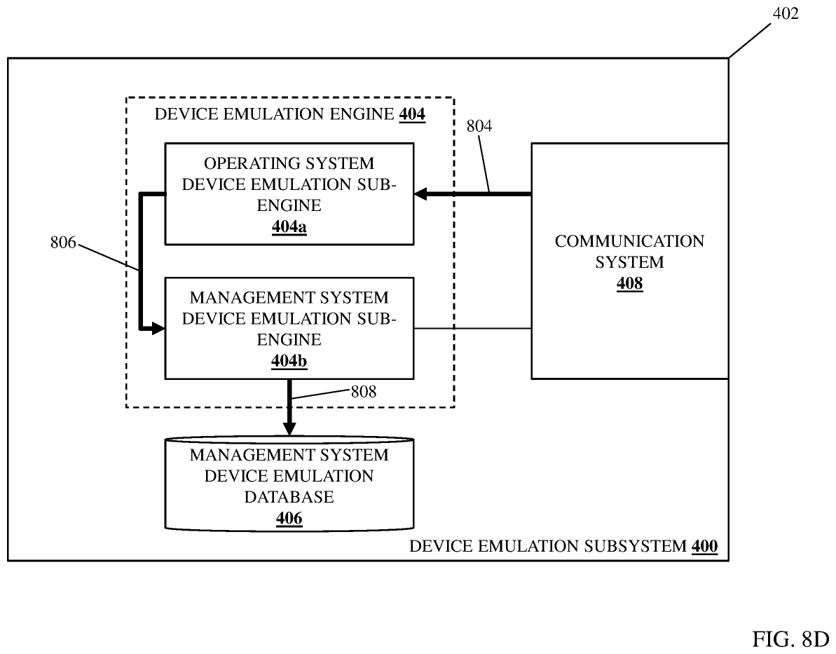

With reference to FIGS. 8A and 8B, in an embodiment of block 504, the management system device emulation sub-engine 404b in the device emulation engine 404 of the device emulation subsystem 312a/400 may perform management information retrieval instruction operations 800 that may include providing an instruction to the operating system device emulation sub-engine 404a in the device emulation engine 404 of the device emulation subsystem 312a/400 to retrieve management information from any of the storage device(s) 206a-206c that are being used to provide the emulated storage device(s) 602. For example, at block 504 the management system device emulation sub-engine 404b may instruct the operating system device emulation sub-engine 404a to retrieve management information such as inventory information for the storage device(s) 206a-206c, temperature information for the storage device(s) 206a-206c, configuration information for the storage device(s) 206a-206c, firmware update information for the storage device(s) 206a-206c, and/or any other storage device management information that would be apparent to one of skill in the art in possession of the present disclosure. In response to receiving the instruction to retrieve the management information, the operating system device emulation sub-engine 404a may perform management information retrieval operations 802 that may include transmitting a request for management information to each of the storage device(s) 206a-206c that are being used to provide the emulated storage device(s) 602 through the network 204 via its communication system 408.

With reference to FIGS. 8C and 8D, in response to receiving the request for their management information, the storage device(s) 206a-206c receiving that request may perform management information transmission operations 804 that may include transmitting management information for that storage device through the network 204 such that it is received by the operating system device emulation sub-engine 404a in the device emulation engine 404 of the device emulation subsystem 400 via its communication system 408. In response to receiving the management information, the operating system device emulation sub-engine 404a may perform management information forwarding operations 806 that include forwarding any management information received from the storage device(s) 206a-206c to the management system device emulation sub-engine 404b in the device emulation engine 404 of the device emulation subsystem 312a/400. In response to receiving the management information from the operating system device emulation sub-engine 404a, the management system device emulation sub-engine 404b may perform management information storage operations 808 that include storing that management information in the management system device emulation database 406. However, while specific techniques for retrieving management information for emulated devices has been described, one of skill in the art in possession of the present disclosure will appreciate how the management information for the emulated storage device(s) 602 may be retrieved from the storage device(s) 206a-206c in a variety of manners that will fall within the scope of the present disclosures as well.

The method 500 then proceeds to decision block 506 where it is determined whether a management information retrieval request directed to the emulated device that is presented as the local device to the management system is received from the management system. In an embodiment, at decision block 506, the management system device emulation sub-engine 404b in the device emulation engine 404 of the device emulation subsystem 312a/400 may monitor the management system physical connection(s) 316 for management information retrieval requests from the BMC device 308. To provide a specific example, the BMC device 308 (e.g., the iDRAC device described above) may be configured to communicate via I2C connections (including the I2C connection in the management system physical connection(s) 316), and may transmit management information retrieval requests using a particular I2C address (e.g., a “0×3A” I2C address) in order to attempt to identify “local” storage devices in the computing device 300, request that any identified storage devices provide their management information (e.g., temperature information for that storage device, configuration information for that storage device, etc.), and/or perform any other storage device management information retrieval operations that would be apparent to one of skill in the art in possession of the present disclosure.

To provide another specific example, the BMC device 308 (e.g., the iDRAC device described above) may be configured to communicate via PCIe connections (including the PCIe connections in the management system physical connection(s) 316), and may transmit (e.g., using the NVMe Management Interface (NMVe-MI) protocol) the management information retrieval requests as part of firmware update operations used to update firmware for the emulated device. As such, the BMC device 308 may transmit firmware update images, reboot the emulated device, and/or perform other firmware update operations out-of-band and over physical PCIe connections in the management system physical connection(s) 316 in a manner similar to in-band firmware update operations performed by the BIOS 306 or operating system engine 304.

As such, at decision block 506, the management system device emulation sub-engine 404b may “listen” or otherwise monitor the particular I2C address used by the BMC device 308 to retrieve management information from storage devices via the I2C connection in the management system physical connection(s) 316 to determine whether the BMC device 308 is directing a management information retrieval request to the emulated storage device(s) 602. However, while a particular technique for determining whether a management information retrieval request has been directed to an emulated device has been described, one of skill in the art in possession of the present disclosure will appreciate how other techniques for determining whether a management information retrieval request has been directed to an emulated device will fall within the scope of the present disclosure as well.

If, at decision block 506, it is determined that a management information retrieval request directed to the emulated device that is presented as the local device to the management system has not been received from the management system, the method 500 returns to block 504. As such, the method 500 may loop such that the device emulation subsystem 312a/400 continues to retrieve management information for the emulated storage device(s) 602 at block 504 until a management information retrieval request is received (i.e., in embodiments in which such management information is retrieved prior to receiving a management information retrieval request), or continues to monitor for the receipt of a management information retrieval request at decision block 506 (i.e., in embodiments in which such management information is retrieved subsequent to receiving a management information retrieval request).

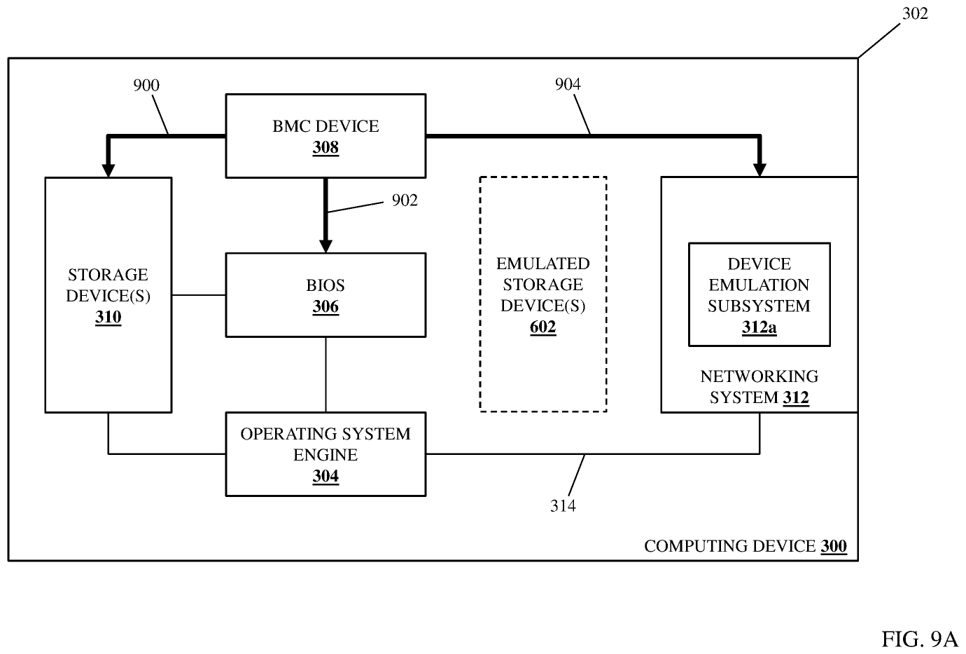

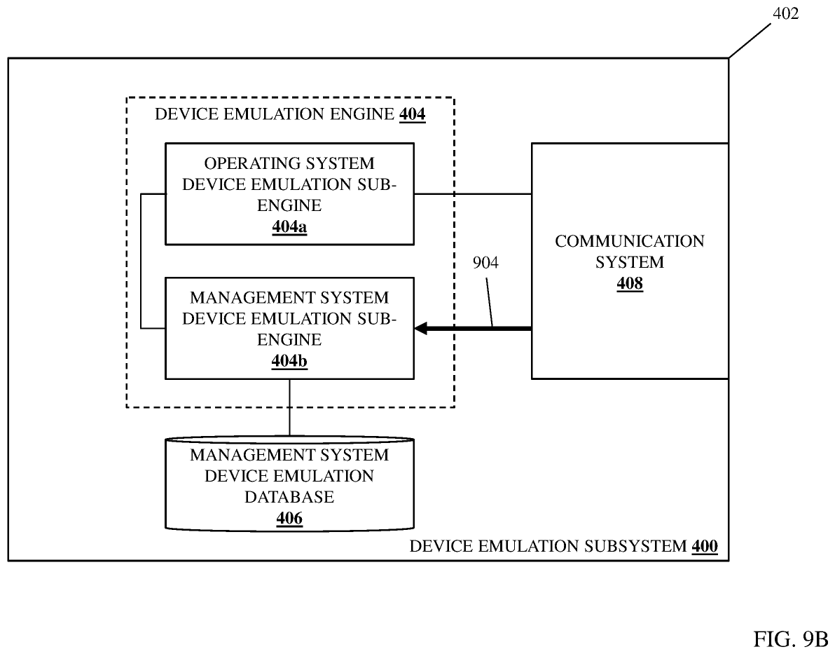

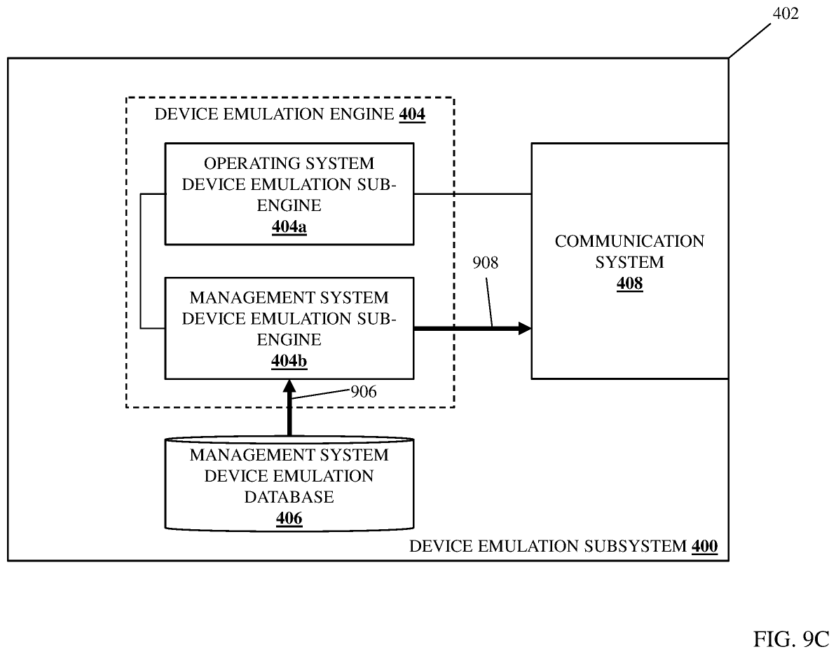

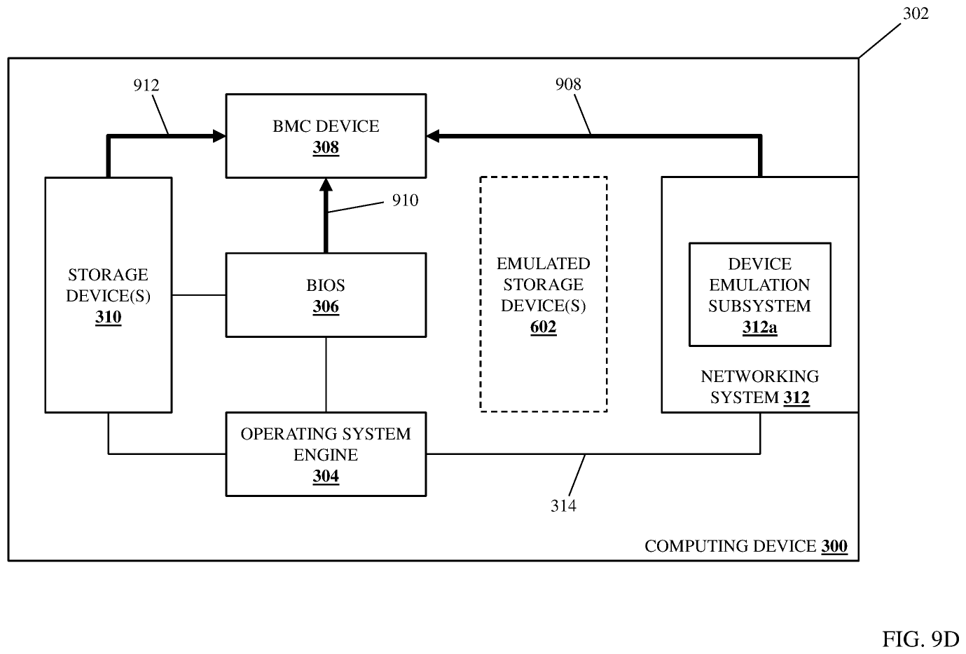

If, at decision block 506, it is determined that a management information retrieval request directed to the emulated device that is presented as the local device to the management system has been received from the management system, the method 500 proceeds to block 508 where the device emulation subsystem provides management information to the management subsystem such that the management information appears to come from the local device that is presented to the management system by the emulated device. With reference to FIGS. 9A and 9B, in an embodiment of decision block 506, the BMC device 308 may perform management information retrieval request operations that, in the illustrated example, include transmitting management information retrieval request(s) 900 that are received by the storage device(s) 310, management information retrieval request(s) 902 that are received by the BIOS 306 (e.g., using BMC/BIOS direct communication protocols that may be available in some computing devices, via an intermediate communication device between the BMC device 308 and the BIS 306, etc.), and management information retrieval request(s) 904 that are received by the management system device emulation sub-engine 404b included in the device emulation engine 404 of the device emulation subsystem 400 via its communication system 408.

Continuing with the specific examples provided above, the BMC device 308 may transmit management information retrieval requests using a particular I2C address (e.g., a 0×3A I2C address) and over I2C connections to each of the storage device(s) 310, the BIOS 306, and the device emulation subsystem 400 in order to request management information for storage devices. As such, with reference to FIGS. 9C and 9D, the management system device emulation sub-engine 404b included in the device emulation engine 404 of the device emulation subsystem 312a/400 (which as discussed above is “listening” or otherwise monitoring that particular I2C address) will determine that the management information retrieval request(s) 904 has been received on the management system physical connection(s) 316 at decision block 506 and, in response, may perform management information retrieval operations 906 that include retrieving the management information that was previously stored in the management system device emulation database 406 at block 504. As will be appreciated by one of skill in the art in possession of the present disclosure, in some examples, the management information retrieval operations 906 may include retrieving a subset of the management information that was previously stored in the management system device emulation database 406 at block 504 (e.g., the most recently stored management information, management information directed to a particular management characteristic defined or otherwise identified in the management information retrieval request, etc.).

Furthermore, as discussed above, rather than retrieving management information that was previously stored in the management system device emulation database 406 at block 504, at block 508 and in response to receiving the management information retrieval request(s) 904, the management system device emulation sub-engine 404b included in the device emulation engine 404 of the device emulation subsystem 312a/400 may instead cause that management information to be retrieved by the operating system device emulation sub-engine 404a similarly as described above with reference to block 504. In other words, in response to determining that the management information retrieval request(s) 904 were received at decision block 506, the management system device emulation sub-engine 404b may cause the operating system device emulation sub-engine 404a to retrieve management information from the storage device(s) 206a-206c that are being used to provide the emulated storage device(s) 602 and provide that management information to the management system device emulation sub-engine 404b.

In response to retrieving and/or receiving the management information, the management system device emulation sub-engine 404b included in the device emulation engine 404 of the device emulation subsystem 312a/400 may perform management information provisioning operations 908 that include providing that management information via its communication system 408 and through the management system physical connection(s) 316 to the BMC device 308. As will be appreciated by one of skill in the art in possession of the present disclosure, the provisioning of the management information for the emulated storage device(s) 602 by the management system device emulation sub-engine 404b through the management system physical connection(s) 316 to the BMC device 308 in response to the management information retrieval request(s) 904 operates to “impersonate” local storage devices presented by the emulated storage device(s) 602 such that the BMC device 308 “believes” that it is communicating with local storage devices in the computing device 300, and one of skill in the art in possession of the present disclosure will appreciate how the management information provisioning operations 908 performed by the management system device emulation sub-engine 404b may include any other actions or functions that would operate to “impersonate” local storage devices presented by the emulated storage device(s) 602 to the BMC device 308.

As also illustrated in FIG. 9D, in response to receiving the management information retrieval request 902, the BIOS 306 may perform management information provisioning operations 910 that may include transmitting any of the inventory information generated for the storage device(s) 310 and the emulated storage device(s) 602 in response to the inventory operations 700 discussed above. Similarly, in response to receiving the management information retrieval requests 900, the storage device(s) 310 may perform management information provisioning operations 912 that may include transmitting any management information available to those storage device(s) 310, and one of skill in the art in possession of the present disclosure will appreciate how the management information transmitted by the storage device(s) 310 may be similar to the management information provided by the device emulation subsystem 312a to the BMC device 308 for the emulated storage device(s) 602. The method 500 then returns to block 504. As such, the method 500 may loop such that, when the BMC device 308 provides management information retrieval requests, the device emulation subsystem 312a identifies those management information retrieval requests and returns management information for the emulated storage device(s) 602 to the BMC device 308 in response such that that management information appears to come from local storage devices in the computing device 300.

Thus, systems and methods have been described that provide for the emulation of physical NVMe-oF storage devices, which are being emulated to an operating system in a server device, to a BMC device in that server device as well. For example, the emulated device management system of the present disclosure may include a chassis housing a device emulation subsystem coupled to an operating system via operating system physical connection(s) and to a BMC device via BMC device physical connection(s). The device emulation subsystem emulates a physical NVMe-OF storage device to provide an emulated NVMe storage device that is presented to the operating system as a local NVMe storage device connected to the operating system physical connection(s), and presented to the BMC device as a local NVMe storage device connected to the BMC device physical connection(s). When the device emulation subsystem receives a management information retrieval request from the BMC device that is directed to the local NVMe storage device presented to the BMC device, it retrieves management information for the emulated NVMe storage device and provides the management information to the BMC device via the BMC device physical connection(s) such that the management information appears to come from the local NVMe storage device presented to the BMC device. As such, the BMC device in a server device that is used to manage physical NVMe storage devices in that server device (i.e., “local” NVMe storage devices) may be used to manage emulated NVMe storage devices utilized by the operating system in the server device as well.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

what is claimed is:

1. An emulated device management system, comprising:
a computing device chassis;
an operating system that is provided in the computing device chassis;
a management system that is included in the computing device chassis; and
a device emulation subsystem that is provided in the computing device chassis, that is coupled to the operating system via at least one operating system physical connection, and that is coupled to the management system via at least one management system physical connection, wherein the device emulation subsystem is configured to:
emulate a physical device to provide an emulated device that is:
presented to the operating system as a local device that is connected to the at least one operating system physical connection; and
presented to the management system as a local device that is connected to the at least one management system physical connection;
receive, from the management system via the at least one management system physical connection, a management information retrieval request that is directed to the local device presented to the management system by the emulated device;
retrieve, in response to receiving the management information retrieval request, management information for the emulated device; and
provide, to the management system via the at least one management system physical connection, the management information such that the management information appears to come from the local device presented to the management system by the emulated device.

2. The system of claim 1, wherein the device emulation subsystem is included in a networking system that is included in the computing device chassis.

3. The system of claim 1, wherein the device emulation subsystem is provided by a Data Processing Unit (DPU).

4. The system of claim 1, wherein the at least one management system physical connection includes a Peripheral Component Interconnect express (PCIe) physical connection and an Inter-Integrated Circuit (I2C) physical connection.

5. The system of claim 1, wherein the device emulation subsystem includes:
an operating system device emulation engine that is configured to emulate the physical device to provide the emulated device that is presented to the operating system; and
a management system device emulation engine that is configured to emulate the physical device to provide the emulated device that is presented to the management system, and wherein in response to receiving the management information retrieval request, the management system device emulation engine instructs the operating system device emulation engine to access the physical device in order to retrieve the management information for the emulated device.

6. The system of claim 1, wherein the device emulation subsystem periodically accesses the physical device to retrieve management information for the physical device prior to receiving the management information retrieval request, stores the management information for the physical device in an emulated device management database and, in response to receiving the management information retrieval request, retrieves a subset of the management information for the physical device from the emulated device management database in order to retrieve the management information for the emulated device.

7. An Information Handling System (IHS), comprising:
a processing system; and
a memory system that is coupled to the processing system and that includes instructions that, when executed by the processing system, cause the processing system to provide a device emulation engine that is configured to:
emulate a physical device to provide an emulated device that is:
presented to an operating system as a local device that is connected to the processing system by at least one operating system physical connection; and
presented to a management system as a local device that is connected to the processing system by at least one management system physical connection;
receive, from the management system via the at least one management system physical connection, a management information retrieval request that is directed to the local device presented to the management system by the emulated device;
retrieve, in response to receiving the management information retrieval request, management information for the emulated device; and
provide, to the management system via the at least one management system physical connection, the management information such that the management information appears to come from the local device presented to the management system by the emulated device.

8. The IHS of claim 7, wherein the IHS is provided by a networking system that is included in a chassis that houses the management system and the operating system.

9. The IHS of claim 8, wherein the networking system includes a Smart Network Interface Controller (SmartNIC).

10. The IHS of claim 7, wherein the processing system is provided by a Data Processing Unit (DPU).

11. The IHS of claim 7, wherein the at least one management system physical connection includes a Peripheral Component Interconnect express (PCIe) physical connection and an Inter-Integrated Circuit (I2C) physical connection.

12. The IHS of claim 7, wherein the device emulation engine includes:
an operating system device emulation sub-engine that is configured to emulate the physical device to provide the emulated device that is presented to the operating system; and
a management system device emulation sub-engine that is configured to emulate the physical device to provide the emulated device that is presented to the management system, and wherein in response to receiving the management information retrieval request, the management system device emulation engine instructs the operating system device emulation engine to access the physical device in order to retrieve the management information for the emulated device.

13. The IHS of claim 7, wherein the device emulation engine periodically accesses the physical device to retrieve management information for the physical device prior to receiving the management information retrieval request, stores the management information for the physical device in an emulated device management database and, in response to receiving the management information retrieval request, retrieves a subset of the management information for the physical device from the emulated device management database in order to retrieve the management information for the emulated device.

14. A method for managing emulated devices in a computing device, comprising:
emulating, by a device emulation subsystem, a physical device to provide an emulated device that is:
presented to an operating system as a local device that is connected to the processing system by at least one operating system physical connection; and
presented to a management system as a local device that is connected to the processing system by at least one management system physical connection;
receiving, by the device emulation subsystem from the management system via the at least one management system physical connection, a management information retrieval request that is directed to the local device presented to the management system by the emulated device;
retrieving, by the device emulation subsystem in response to receiving the management information retrieval request, management information for the emulated device; and
providing, by the device emulation subsystem to the management system via the at least one management system physical connection, the management information such that the management information appears to come from the local device presented to the management system by the emulated device.

15. The method of claim 14, wherein the IHS is provided by a networking system that is included in a chassis that houses the management system and the operating system.

16. The method of claim 15, wherein the networking system includes a Smart Network Interface Controller (SmartNIC).

17. The method of claim 14, wherein the processing system is provided by a Data Processing Unit (DPU).

18. The method of claim 14, wherein the at least one management system physical connection includes a Peripheral Component Interconnect express (PCIe) physical connection and an Inter-Integrated Circuit (I2C) physical connection.

19. The method of claim 14, wherein the device emulation subsystem includes:
an operating system device emulation sub-engine that is configured to emulate the physical device to provide the emulated device that is presented to the operating system; and
a management system device emulation sub-engine that is configured to emulate the physical device to provide the emulated device that is presented to the management system, and wherein in response to receiving the management information retrieval request, the management system device emulation engine instructs the operating system device emulation engine to access the physical device in order to retrieve the management information for the emulated device.

20. The method of claim 14, wherein the device emulation subsystem periodically accesses the physical device to retrieve management information for the physical device prior to receiving the management information retrieval request, stores the management information for the physical device in an emulated device management database and, in response to receiving the management information retrieval request, retrieves a subset of the management information for the physical device from the emulated device management database in order to retrieve the management information for the emulated device.
